(19) United States
(12) Patent Application Publication
(10) Pub. No.: US 2025/0139064 A1
(43) Pub. Date: May 1, 2025

(54) Method for automatically expanding factor graph databases

(71) Applicant: Verses AI, Inc., New Westminster (CA)

(72) Inventors: Joseph Lee, Waterloo (CA); Jakub Smékal, Stanford, CA (US); Tim Verbelen, Dendermonde (BE); Ozan Catal, Ghent (BE); Alexander D.D. Tschantz, Hove (GB); Mahault Albarracin, Montreal (CA)

(21) Appl. No.: 18/927,933

(22) Filed: Oct. 26, 2024

Related U.S. Application Data
(60) Provisional application No. 63/593,745, filed on Oct. 27, 2023.

(51) Int. Cl. G06F 16/21; G06F 16/901

(52) U.S. Cl. CPC G06F 16/211; G06F 16/9024

(57) ABSTRACT

The expansion of a computer graph database upon receipt of novel information involves identifying whether the novel information should be stored as part of the existing categories contained in the computer graph database, thereby requiring the addition of a new variable to an extant category of the computer graph database, or whether the new information should be stored as a new category that intersect with extant categories of the computer graph database, thereby requiring an extension of a relation between two or more extant categories, or whether the new information should be stored as a new category that only connects to a single extant category, thereby requiring the creation of a new portion of the computer graph database.

### FIELD OF INVENTION

This application explores graph database expansion methods.

### BACKGROUND

Graph databases are queryable data stores that store information about the relation between the entities being stored using a graph structure, with nodes representing the entities, and edges representing the parent-child, or cause-consequence relationship between those entities—see definition section. Graph databases are used in software designed for information retrieval about systems that include entities related to one another in a graph-like manner, such as social networks, or for storing and retrieving information about entities related to one another in a physical space such as a warehouse. Graph databases thus store information that can be used by various devices like robots and drones to perform their task (e.g., storing the information about the location of a box in a warehouse).

For instance, a graph database may store information about some “B” entities being on some “A” entities (e.g., the boxes “B” are on the shelves “A”), where boxes “B” may include a variety of elements such as box 1 (b1) and box 2 (b2), and where the shelves in the room “A” may include a variety of elements such as a shelf 1 (a1) and shelf 2 (a2). This relation will be stored in a graph structure as A (a1, a2)-B (b1, b2).

Upon receipt of novel information, the database must be expanded, which means that the graph structure must be expanded. Concretely, expansion happens when new information about events in the environment become available and must be stored (e.g., a box “b3” has been added to a shelf, such as shelf “a1” in the warehouse). The way the novel information relates to other nodes in the graph must then be specified, explicitly (e.g., by an engineer), to determine the way the graph should be expanded. The problem that must be solved when expanding the graph is to determine whether the new information should be treated as an element of an existing entity (e.g., “A” or “B”), or as a whole new entity (e.g, a new entity “C”). This problem is normally solved manually, by an engineer. For instance, upon receipt of information about C, one must decide whether C relates independently to A or B, such that the graph structure should be expanded to include A-B as well as A-C (i.e., the creation of a new graph structure); or if C mediates the relationship between A and B, such that the graph structure should be expanded as A-C-B (i.e., the extension of the existing graph structure); or if C is simply an additional information that can be added to A or to B (i.e., the extension of an already existing variable in the graph structure), which would not change the graph structure (e.g., if the new information is in fact another element of A such as “a3”).

### SUMMARY OF THE INVENTION

The claimed invention provides a novel method of automatically expanding graph databases that implement factor graphs known as factor graph databases—see definitions—upon receipt of novel information. Factor graph databases are computation graph databases—see definitions—that store probabilistic conditional relation between entities stored in the graph database (e.g., the probability that box 1 is on shelf 2). The claimed method allows for automatically expanding factor graph databases by deciding whether, upon receipt of information, the graph structure of the factor graph database should undergo a variable extension (e.g., adding an element “b3” to an existing entity “B”), or a graph extension, that is, the extension of an existing relationship between two entities to a new entity (e.g., adding a connection between a new entity “C” and its elements c1, c2, c3 . . . to the connection between the existing entities “A” and “B”) as further discussed below with respect to FIG. 6, or a graph creation, that is the creation of a new connection that relates an existing entity to a new entity (e.g., creating a connection between an existing entity “A” and a new entity “C”) as further discussed below with respect to FIG. 7.

### BRIEF DESCRIPTION OF THE DRAWINGS

FIG. 1 illustrates the structure of one embodiment of a simple computation graph database with two nodes;

FIG. 2 illustrates the structure of one embodiment of a computation graph database performing a particular mathematical operation;

FIG. 3 shows an embodiment of a structure of a factor graph database treated as a computation graph database;

FIG. 4 is a flowchart of one embodiment of a factor graph database expansion process;

FIG. 5 illustrates one embodiment of the process of variable extension;

FIG. 6 illustrates one embodiment of the process of graph extension, and

FIG. 7 illustrates one embodiment of the process of graph creation.

### DEFINITIONS

Databases are queryable data stores. The three common classes of databases are the relational databases, the graph databases, and the vector databases. Compared to relational and vector databases, graph databases store data in a way that allows for querying by looking at parent-child relationships between the stored entities (e.g., “give me the child entities to the Steve entity). Databases represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect source nodes (e.g., the parent or cause nodes) and the destination nodes (e.g., the children or the consequence node), and that can give cause-consequence, or parent-child information.

A computation graph database is a directed graph, which includes source and destination nodes that represent variables, and which further includes edges representing transformations in the value of a destination node that can occur when an update happens to a connected source node. The terms “entity”, “node” and “variable” are used interchangeably. A computation graph database is a graph database that can be used to perform mathematical operations over the stored entities.

A factor graph is a type of probabilistic graphical model that can be used to perform inferences over the entities represented by the nodes in the graph. A factor graph consists of two types of nodes: (i) factor nodes, which represent factors or functions that relate multiple variables together (e.g., the function that multiplies the elements x1, x2, x3 . . . of a variable X with the elements y1, y2, y3 . . . of a variable Y), (ii) and variable nodes, which represent the variables in the model. For the factor graphs used in this invention, we use a bipartite graph representation and partition the graph into factor nodes and variable nodes. The factor nodes are connected to the variable nodes that they depend on, and the graph structure reflects the conditional dependencies between the variables. Variable nodes are denoted by circles and correspond to variables over which the inference algorithm applies. Variable nodes are entities of the factor graph database. Factor nodes are denoted by squares and denote the relation between variables, or entities. In the context of this invention, they encode the data that represents the probabilistic relation between entities, and that can be used by an inference program to perform probabilistic querying.

A factor graph database is a computation graph database over which factor graph operations such as message passing are performed to infer values of unobserved nodes. The method of the invention for expanding graph databases applies to factor graph databases, which are computer graph databases structured as factor graphs, and that are able to perform factor graph operations such as message passing.

A Large Language Model (LLM) is a model part of the class of computational models known as foundation models. Foundation models are computational models that are pre-trained on a large amount of data. LLMs are foundation models that have been trained on text data, specifically (e.g., text files found online). By analogy, an LLM is like a person that would have read and encoded the information coming from a vast amount of texts (e.g., has read many books, websites, etc.) and that could combine the knowledge that she has acquired to respond to various queries (e.g., “what is the color of the sky?”). An LLM is built out of the combination of three elements: (i) text data, (ii) a computational architecture, and (iii) a training process. Depending on the LLM, the computational architecture will differ. For instance, for well known LLMs such as chat GPT, the computational architecture used is a neural network that has a transformer architecture. Transformer architectures perform 1-to-many string comparisons (e.g., comparing a sentence to all similar sentences) to then generate new sentences that are informed by the syntax of the already known sentences. The process starts with an encoding step that involves: (i) transforming the natural language into word embeddings, which are numerical representations of the words (i.e., strings of numbers), (ii) estimating the normal position of the words and sentences, with respect to one another, which is made possible by the conversion of the words into their numerical equivalent (e.g., “The” comes before “sky”), (iii) tracking the normal relationship between the words turned into numerical representations using a process called self-attention (e.g., words like “blue” relate to names like “sky”, and not articles like “the” when they are positioned after names like “sky”). The encoded sentences can then be used to perform various mathematical operations to further compare the sentences, find similar sentences, predict what words could be used to complete the sentences, find sentences that respond to other sentences, etc. With respect to how LLMs are used in general, and in this invention, text inputs known as “prompts” are used as inputs to the LLM to generate text output that function as responses to the prompt. Prompts can be questions (e.g., what is the color of the sky?) or imperative statements (e.g., write a computer code that can be implemented to generate sky in a game engine). Prompts are structured in a way that can elicit the desired response—similar to how one would structure a question posed to humans so as to elicit a certain response. The activity of engineering a prompt to elicit the desired response is called “prompt engineering”. In summary, LLMs are used as tools for responding to natural language queries, just like calculators may be used for responding to a query in mathematical language (e.g., “what is 2+2?”). Prompt engineering is the activity of asking the right question to an LLM (e.g., asking “what is 2+2” when looking for an addition instead of asking “what is 2×2”). LLM is a foundation model trained on text data that takes as input an engineered text “prompt”, and that process that prompts to generate an output, which is the response that corresponds to the prompt. This invention is not limited to the use of LLMs based on transformer neural networks, but to LLMs in general. The claimed method covers any computer system able to receive a prompt-like input and to generate the appropriate response to the prompt.

Factor graph expansion necessitates expanding a factor graph database upon receipt of novel information. In accordance with the invention this is automated. In one embodiment of the invention, this is implemented as a class in the Python programming language and is composed of a compare method that uses a series of engineered prompts (prompts 1 and 2) passed to a Large Language Model (LLM)—see definitions—to determine the relationship between the new variables and the existing variables (e.g., to determine if the novel information is an element of A or B, or if it is a whole new variable), and a graph method that stores the new element of an existing variable (variable extension), as an extension of the graph structure (graph extension), or as a created portion of the graph (graph creation) and adjusts the graph accordingly, based on the rules established by the graph method.

### DETAILED DESCRIPTION

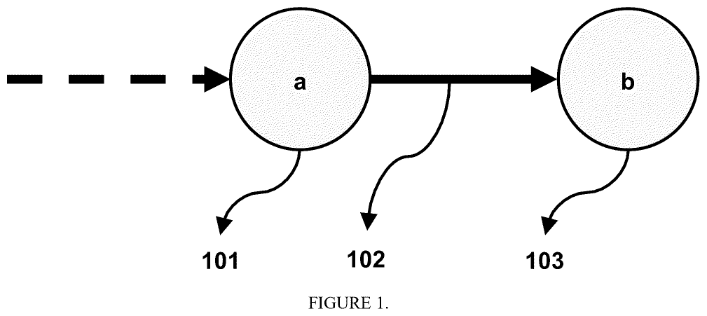

FIG. 1 illustrates the structure of a simple computation graph database with two nodes: source node 101, and destination node 103, related to each other by an edge 102. A graph database gives parent-child information about the entities contained in the database. The graph database represents parent-child information by using the edge 102 relating the source entity 101 and the destination entity 103. The information encoded by this graph database may be, for instance, the box “b1” is on (i.e., is a child of) the shelf “a1” (i.e., node a is a child of) (i.e., of its parent node b).

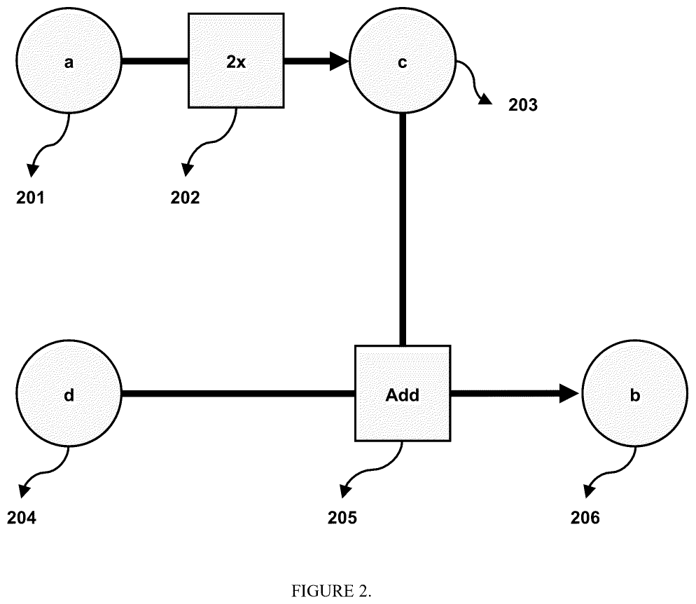

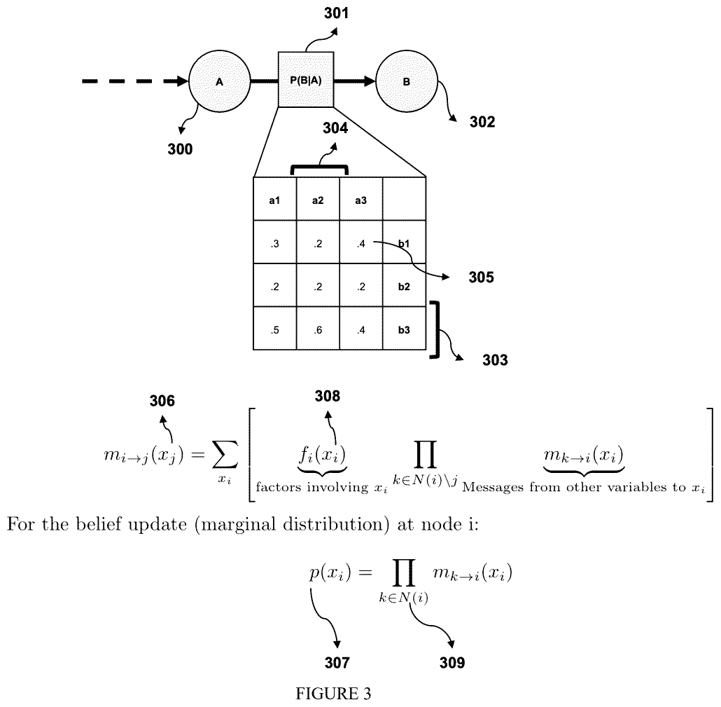

FIG. 2 illustrates the structure of a computation graph database performing a mathematical operation “b=2a+d” over the source node “a” and a destination node “b”. The update rule is represented as a mathematical operation whose description is encoded in the graph database (e.g., operations represented as squares in FIGS. 2 and 3 operating on factor nodes and intermediary nodes) and operated through a call to a programming language. In FIG. 2, this is defined by source node a (201) being subjected to a multiplication operation 202 to define interim node 203. Node d (204) is added by “Add” operation 205 to the value of interim node 203 to define destination node b (206). The function of a computation graph database is to update a destination node (e.g., b) when a change in a source node (e.g., a) happens. When change in an entity a (201) is observed, the value of the entity b (206) is updated. The update rule is operated through two transforms, which are transform 202, which calculates two times the value of a (2a) to define variable c 203, and transform 205, which adds variable c to variable d 204 to update variable b 206. This operation thus requires an intermediary entity c 203 that is constructed for the purposes of evaluating the expression operated by the transform in 205.

FIG. 3 shows the structure of a factor graph database treated as a computation graph database. As a type of computer graph database, a factor graph database can perform operations such as message passing to update the variables stored in the database. The factor graph relates a source node a (300) and a destination node b (302), and their relating factor encoding information 301 about the conditional probability of elements of the variable b relating to elements of the variable a. The probabilities are presented as mappings in matrices (or in tensors). 304 indicates that the column of the matrix corresponds to a probability distribution (i.e., must sum to 1, e.g., 0.2+0.2+0.6). Each cell encodes a probabilistic mapping between the variable represented by the column (e.g., elements of a such as a1, a2, a3) and the variable represented by the rows (e.g., elements of the variable b such as b1,b2,b3). Reference numeral 303 indicates the rows that represent the observed variable, or the children of an entity. Reference numeral 305 indicates that the probability of b1 to be related to a3 is 40% (0.4). The mathematical operation performed by the factor graph database is an inference algorithm represented in the equation (306-309). The algorithm operation is a message passing algorithm that computes the message from node i (e.g., a) to node j (e.g., b) defined as the summation over all possible values of the entity i such as encoded by the data field of the data link 306. 307 is the marginal probability of node i, 308 is the factor associated with node i, and 309 is the set of neighbors of node i. The method for expanding a factor graph database is a method that allows automatically expanding the rows, columns, or number of factors in a factor graph database upon request.

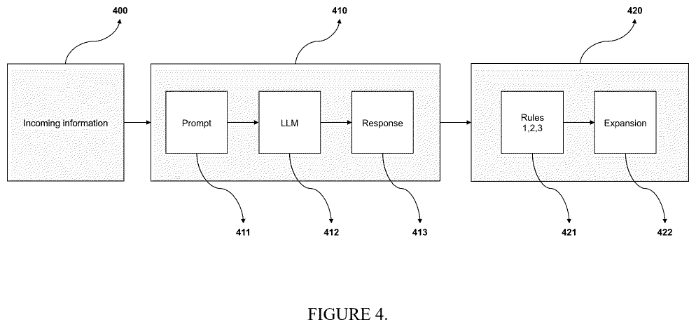

FIG. 4 presents a flowchart of the factor graph database expansion process. The expansion of a factor graph database in accordance with the present invention involves a compare method (410) and a graph method (420). In one implementation, the compare method (410) uses a set of logical steps involving prompts, or questions that are passed to an LLM that determines whether the expansion should be a variable extension, a graph extension, or a new graph creation. Upon receipt of a novel information (400) that can come from a user interaction with the database (e.g., a worker scanning objects for inventory), or from observations made by a robot or a IoT device (e.g., a robot sensing an object on the loading dock of a warehouse) the compare method (410) engineers a prompt (411) that is passed as input to an LLM (412) to generate an output response (413 to the prompt 411). The structure of the prompt includes two parts as follows: Part 1: Is the new information, e.g., a new element of an existing entity A or B (e.g., a “box”)?; Part 2: Is the new information in a parent-child or cause-consequence relation to A or B (e.g., if the new information is a “level” of a shelf a1 in the variable A, then the new information is a child variable to A). The graph method (420) starts by verifying the application of the following expansion rules (421): if yes to prompt 1, then the new information is added as an element to A or B (rule 1: variable extension); if no to prompt 1, then verify the answer to prompt 2: if the new information is only related to A (rule 2: graph creation), then the new information is created as a new graph structure related to A; if the new information is only related to B (rule 2: graph creation), then the new information is created as a new graph structure related to B, if the new information is related to A and B (rule 3: graph extension), then the new information is created as a new graph structure mediating A and B. The graph is expanded according to the applying rule (422) using a computer system and programming language.

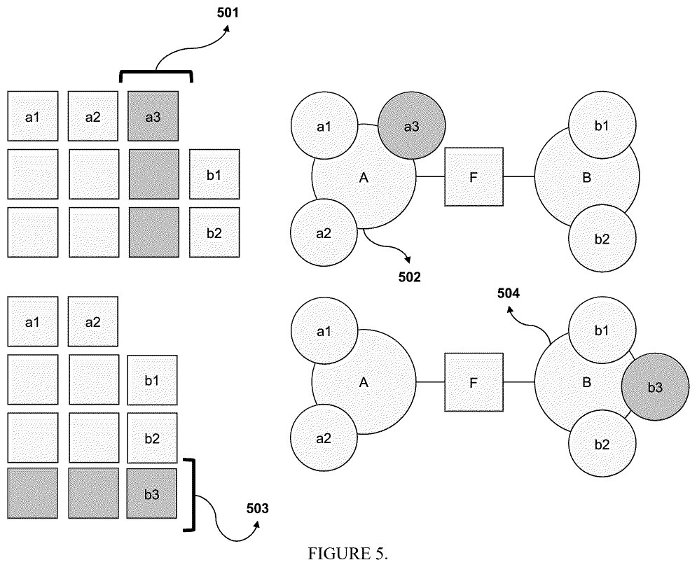

FIG. 5 illustrates the process of variable extension when rule 1 applies. In case of variable extension a column 501 or a row 503 is added to the factor “F” to reflect the expansion of the elements in either the variable A 502 A or variable B 504. This happens if, upon the results of the compare method, it is determined that the new information is an instance of B or A (e.g., if the new information is a new box “b3” or a third shelf “a3”).

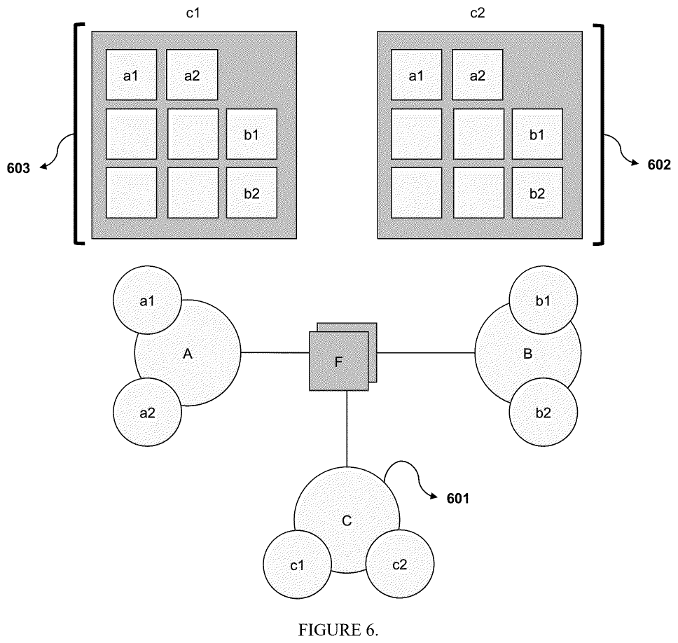

FIG. 6 illustrates the process of graph extension when rule 2 applies. Graph extension applies, for instance, if the new information mediates the relation between the existing information (e.g., if the new information is that the boxes “b1” and “b2” are on different levels “c1” and “c2” of the shelves “a1” and “a2”). The new information concerning the presence of levels “c1” and “c2” in the shelves may be encoded as a new variable “C” with its elements (e.g., elements c1 and c2) 601. In this case, “c1” may be the shelf level 1, and “c2” may be the shelf level 2. The factor F would encode the probability of each box b1 and b2 to be on either level 1 c1 or level 2 c2 of shelves a1 or a2. In terms of the structure of the factor, this involves adding a third dimension to the factor, which corresponds to the probability 603 of A,B and c1 (P (c1|A,B)), and the probability 602 of A,B and c2 (P (c2|A,B)).

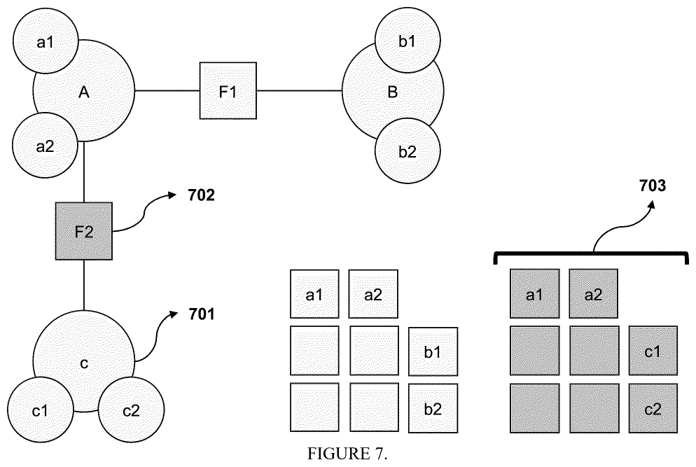

FIG. 7 illustrates the process of graph creation when rule 3 applies. In case of graph creation a novel node 701 is linked to an existing node through a novel factor 702 (F2) that encodes through probability 703 the probabilistic relation between the elements of C (i.e., c1 and c2) and the elements of A (i.e., a1 and a2). Graph creation occurs if the new information in C is independently related to only A or B. This will be the case, for instance, if the new information corresponds to tag numbers “c1” and “c2” associated with the shelves on which the boxes sit. The tag number is only related to the shelves, and not directly to the boxes; hence graph creation leads to adding an edge and a factor to relate A and the new information C.

For purposes of this application the term factor graph databases includes any database that has attributes allowing for factor graph operations.

What is claimed is:

1. A method performed by one or more computers for automatically expanding a factor graph database implemented as a computation graph, wherein the computation graph implementing the factor graph database includes one or more source nodes, one or more destination nodes, and links connecting the source nodes with the destination nodes, wherein one or more of the links define the probabilistic relation between the source and destination nodes, the method comprising,
providing a factor graph database implemented as a computation graph capable of computation over parameters encoding the probabilistic relationship between stored source and destination entities, which are defined as source and destination nodes in the computation graph implementing the factor graph database, and wherein the computation graph includes parameters that are defined as links over which expansion can be performed,
predefining rules for all the possible expansions of the parameters of the factor graph database implemented by the links of the factor graph database that can occur upon receipt of new information,
upon receipt of new information, comparing data strings to determine whether the received information is already represented by the parameters of the computation graph, or is new information distinct from the information already represented by the parameters of the computation graph,
upon determination that the information received is not already represented by the parameters of the computation graph that implements the factor graph database, expanding the factor graph database according to the predefined expansion rule that is appropriate based on the information received.

2. A method of claim 1, wherein the parameters of the computation graph implementing the factor graph database are matrices or tensors that map the probabilistic relation between the source entities represented in the parameter as one of the dimensions of a matrix or tensor and the destination entities represented in the parameter as another dimension of the same matrix or tensor.

3. A method of claim 2, wherein each dimension of the matrix or tensor represents one or more elements of a probability distribution.

4. A method of claim 1, wherein graph expansion is done according to an extension rule for the addition of a new element to an already existing probability distribution in the parameters associated with the factor graph database.

5. A method of claim 1, wherein graph expansion is done according to an extension rule for the addition of a new probability distribution that did not exist previously in the parameters associated with the factor graph database.

6. A method of claim 1, wherein graph expansion is done according to an extension rule for the addition of a new matrix or tensor encoding a set of probability distributions representing the relationship between a new source or destination node that did not exist previously in the factor graph database.
